(19) United States
(12) Patent Application Publication
(10) Pub. No.: US 2012/0089445 A1
(43) Pub. Date: Apr. 12, 2012

(54) TRAFFIC LIGHT ELECTRONIC DISPLAY INTERFACE SYSTEM AND METHOD

(76) Inventor: Alber Hot, Holmdel, NJ (US)

(21) Appl. No.: 12/902,781

(22) Filed: Oct. 12, 2010

(51) Int. Cl. G06Q 30/00; G09F 19/00

(52) U.S. Cl. 705/14.4; 705/1.1; 40/463

(57) ABSTRACT

A method and system for safely providing electronic advertising to viewers at controlled traffic intersections.

### FIELD OF THE INVENTION

The invention relates to the field of electronic advertising systems and, more particularly, electronic advertising systems targeting viewers at controlled traffic intersections.

### BACKGROUND OF THE INVENTION

Advertising has become ubiquitous throughout the world in both print form and electronic form. While advertisers seek to convey their message to their target audience, that audience is becoming harder to reach as opportunities for advertising diminish. Advertising in public spaces is necessarily constrained by individual and public safety concerns.

### BRIEF SUMMARY

Various deficiencies of the prior art are addressed by the present invention of methods and systems for safely providing electronic advertising to viewers at controlled traffic intersections.

In one embodiment, imagery associated with advertising or other content is conveyed to vehicle occupants at controlled intersections during the “stop” or “red light” portion of the traffic control cycle. Display devices mounted proximate to the traffic signals provide the advertising. The advertising itself is synchronized to the traffic cycle such that safety concerns are addressed; namely, prior to the traffic light changing from red to green the advertising imagery is removed to avoid distracting the driver prior to and during the “go” or “green light” portion of the traffic control cycle.

In other embodiments, the imagery presented at a controlled intersection includes public address messages, missing child notices, traffic advisory updates and the like.

According to one embodiment, a method for providing electronic messages to a vehicle occupant at a controlled intersection, comprises determining whether a traffic light facing a vehicle is in a stop state and, if so, responsively presenting imagery upon a display device visually aligned with the traffic light such that occupant of the motor vehicle may view the imagery.

According to another embodiment, an Electronic Display Interface (EDI) for use at a controlled intersection comprises a display visually aligned with a corresponding traffic light; and the controller, operative to cause the presentation of imagery upon the display when the corresponding traffic light is in a stop state of operation.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a traffic signal control system using an electronic display interface (EDI) according to one embodiment;

FIG. 2 depicts a flow diagram of an advertising synchronization method according to one embodiment;

FIGS. 3-4 depict display system installations proximate traffic lights according to several embodiments; and

FIG. 5 depicts a system according to one embodiment.

To facilitate understanding, identical reference numerals have been used, where possible, to designate identical elements that are common to the figures.

### DETAILED DESCRIPTION OF THE INVENTION

Embodiments of the present invention will be primarily described within the context of a controlled traffic intersection wherein traffic lights pointing toward drivers signal that the drivers should stop (red light), prepared to stop (yellow light) or proceed through the intersection (green light). The traffic lights made the controlled by a timer, sensors buried in the road (e.g., magnetic sensors to detect the presence of vehicle), sensors mounted nearby (radar or acoustic detectors) or any of the other known mechanisms for controlling traffic lights.

In one embodiment, an Electronic Display Interface (EDI) is coupled to a traffic light. The power source associated with the traffic light is used to power the EDI; optionally, the EDI is associated with power backup schemes such as an uninterrupted power supply (UPS) to maintain power in the event of power glitches and the like. The EDI may comprise a local controller adapted to control the various functions associated with a single intersection. Alternatively, the EDI may comprise a centralized controller adapted to control the various functions associated with multiple intersections.

In one embodiment, a hierarchical control arrangement of EDI is contemplated wherein relevant advertising is sequentially provided to the same one or more vehicles as they traverse intersections. That is, given a sequence of traffic lights such as might exist on a stretch of road in a city, each display device viewed by a vehicle occupant of the vehicle traverses the intersections may be used to provide advertising or other content specifically adapted to augment the advertising or other content previously provided (i.e. fire prior intersections traversed by the vehicle).

The EDI controls one or more display devices such as LCD displays, plasma displays, LCD displays and the like mounted proximate the traffic lights in view of oncoming traffic. In an intersection comprising North-South as well as East-West traffic, respective North, South, East and West display devices may be controlled by the EDI. Generally speaking, the EDI causes the display of advertising, public interest messages and the like on the one or more display devices associated with traffic that is stopped.

The advertising content or public interest messages may comprise still or moving imagery and, optionally, audio information (such as associated with the still or moving imagery, or simply instructive such as for blind pedestrians and the like). In one embodiment, the audio information is transmitted using amplitude modulation (AM), frequency modulation (FM), Bluetooth, 802.11, WiMAX or some other transmission means suitable for use in a motor vehicle.

Advertising content, public interest content and the like are periodically refreshed depending upon the desires of advertisers, government officials and the like. Content may be refreshed via a satellite network, a cellular telephone network, a hardwired/optical network and the like.

In one embodiment, the display devices comprise relatively light weight flat screen monitors mounted next to the traffic light such that there is no height/clearance issue for passing vehicles. The EDI would be programmed and loaded with data via either the cable and/or satellite connection. There would be instantaneous access to all of the locations, in case of an emergency this may save lives.

In one embodiment, the EDI includes equipment suitable for generating a wireless or Wi-Fi hotspot. The Wi-Fi hotspot may comprise an 802.11 or WiMAX hotspot. Other communications technologies may also be employed to provide this function. In one embodiment, each of the hotspots has sufficient range to overlap a neighboring hotspot such that continuous network capabilities are provided to users.

In one embodiment, the hotspot functionality is utilized by control systems within vehicles to help guide the vehicles around traffic jams, help maintain appropriate vehicle spacing and the like. In various modifications of this embodiment, these vehicle control systems utilize information provided by the hotspot to avoid collisions with other cars/pedestrians, to avoid driving the wrong way on one-way streets, to allow automatic engine shutoff such as in the case of a stolen vehicle or operation of vehicle by an intoxicated person and so on.

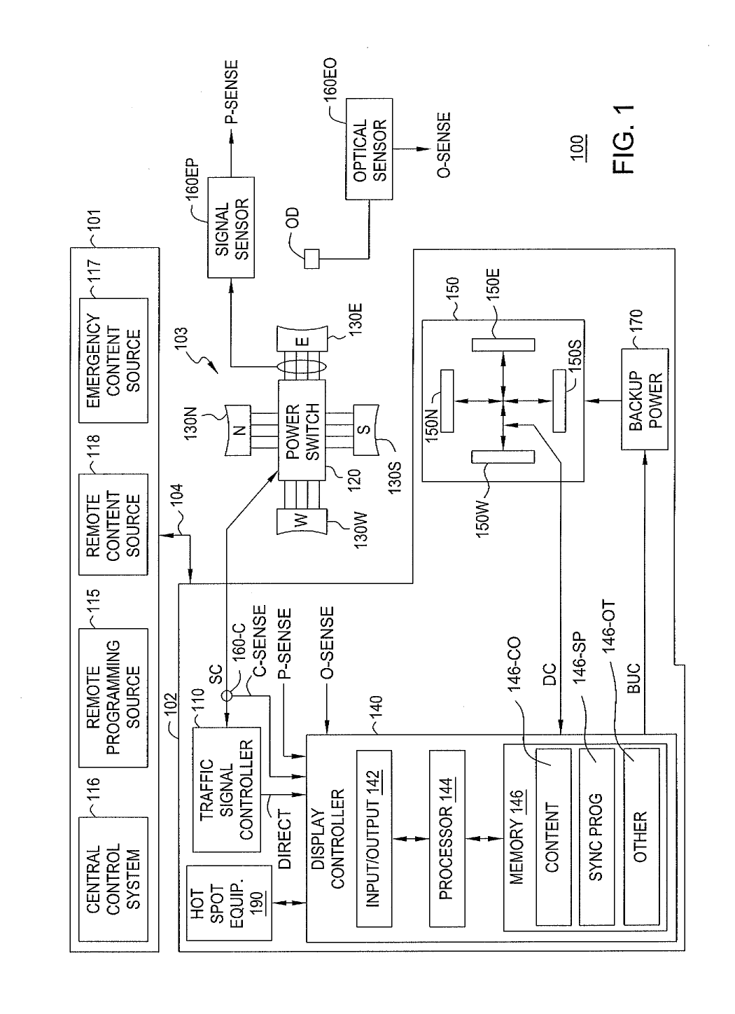

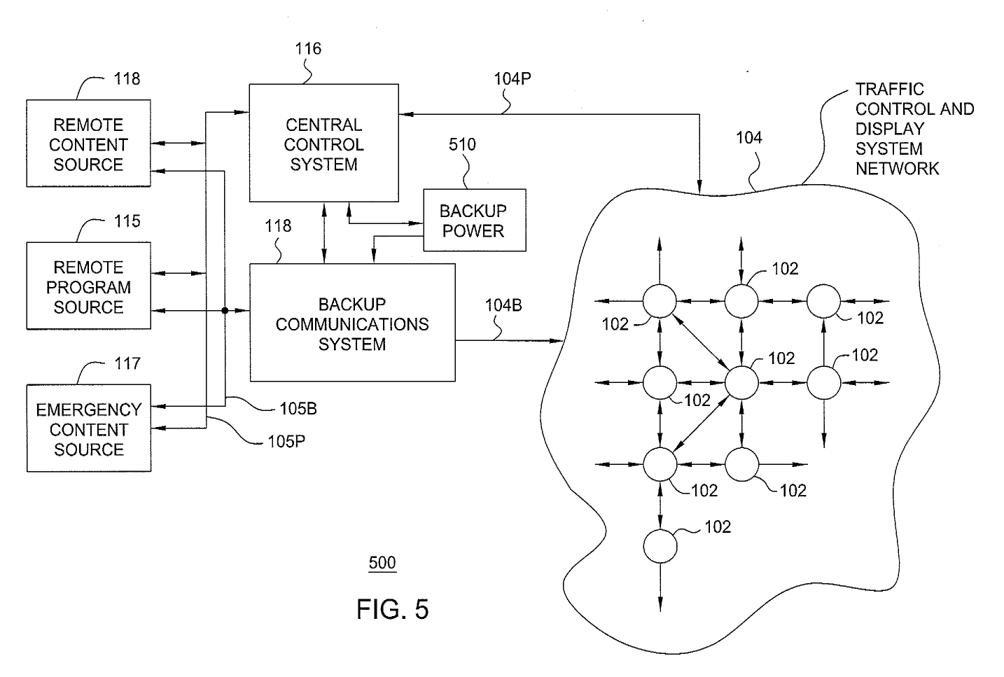

FIG. 1 depicts a high level block diagram of a traffic control system according to one embodiment. Specifically, the traffic control system 100 of FIG. 1 includes a remote or centralized source of control, programming and/or content information 101 in communication with a local EDI 102 via a communications network 104. The local EDI 102 is synchronized in operation with a local traffic signal 103 to provide thereby local advertising and/or other information to drivers proximate the local traffic signal 103. Additional details pertaining to a centralized traffic control systems communicating with multiple local traffic signals and corresponding EDIs will be discussed in more detail low with respect to FIG. 5.

The remote or centralized source of control, programming and/or content information 101 comprises a centralized computing system such as a traffic management system centrally located within a city and controlling the traffic lights within that city. Various portions of the centralized source 101 may be implemented at a single traffic management site or via multiple sites operating in a coordinated manner to provide the functionality described herein.

The remote or centralized source of control, programming and/or content information 101 includes one or more of a central control system 116, a remote programming source 115, a remote content source 118 and an emergency content source 117. The functional elements communicating with the local EDI 102 via a communications network 104, which may comprise a wireless network, wired network, Ethernet network, control loop network and the like.

The functional elements of the local EDT 102 and local traffic signal 103 will be described and explained together. The primary functions of the local EDI 102 are implemented by a traffic signal controller 110 which communicates with and controls the operation of the local traffic signal 103, and a display controller 140 which communicates with and controls the operation of a plurality of displays 150. The local EDI 102 is for the depicted as including hotspot equipment 190, the power backup system 170 and various other elements.

The local traffic signal 103 comprises a plurality of traffic signals or traffic lights 130 (illustratively for traffic lights for respective North, South, East and West lanes of a traffic intersection). The traffic lights 130 are illuminated using power derived from a power switch 120 which is controlled via a control signal SC provided by the traffic signal controller 110. The control signal SC indicates the appropriate state for each of the traffic lights 130 (e.g., red, yellow or green). Typically, the traffic signal controller 110 provides a relatively low voltage/low-power signal to the power switch 120. The power switch 120 provides a higher power signal used to drive the lighting elements within the traffic lights 130, such as incandescent lights, LEDs and the like. The traffic signal controller 110 and power switch 120 may comprise separate functional elements or may be included within the same functional element. The functional elements may be mounted on or near polls used to mount the traffic lights 130.

The external or remote programming source 115 is used to provide updated signaling or sequencing information to the traffic signal controller 110 such that the timing or other operations associated with the control of the respective intersection may be changed. Such changes may occur, example, within the context of managing a plurality of intersections in an urban area to optimize traffic flow at different times of the day.

Various modifications may be made to the traffic control system 100, such as to include more or fewer traffic lights, other types of indications such as colored arrows and the like as is well known to those skilled in the art. Generally speaking, any type of traffic control arrangement or topology may be used within the context of the present invention.

The traffic control system 100 is augmented by, in one embodiment, an Electronic Display Interface (EDI) 102 comprising the display controller 140, the plurality of displays 150, means for sensing a change in traffic light states 160, optional power backup system 170, optional remote content source 118 and optional hot spot (network) equipment 190 suitable for generating or communicatively supporting a wireless network or Wi-Fi hotspot such as an 802.11 or WiMAX hotspot.

The display controller 140 is depicted as a computing architecture or computing element suitable for use in performing the functions described herein. In one embodiment, the display controller 140 comprises various cooperating elements, including a processor element 3144 (e.g., a central processing unit (CPU) and/or other suitable processor(s)), a memory 146 (e.g., random access memory (RAM), read only memory (ROM), and the like) and various input/output devices 142 (e.g., a user input device (such as a keyboard, a keypad, a mouse, and the like), a user output device (such as a display, a speaker, and the like), an input port, an output port, a receiver/transmitter (e.g., an air card or other suitable type of receiver/transmitter), and storage devices (e.g., a hard disk drive, a compact disk drive, an optical disk drive, and the like)).

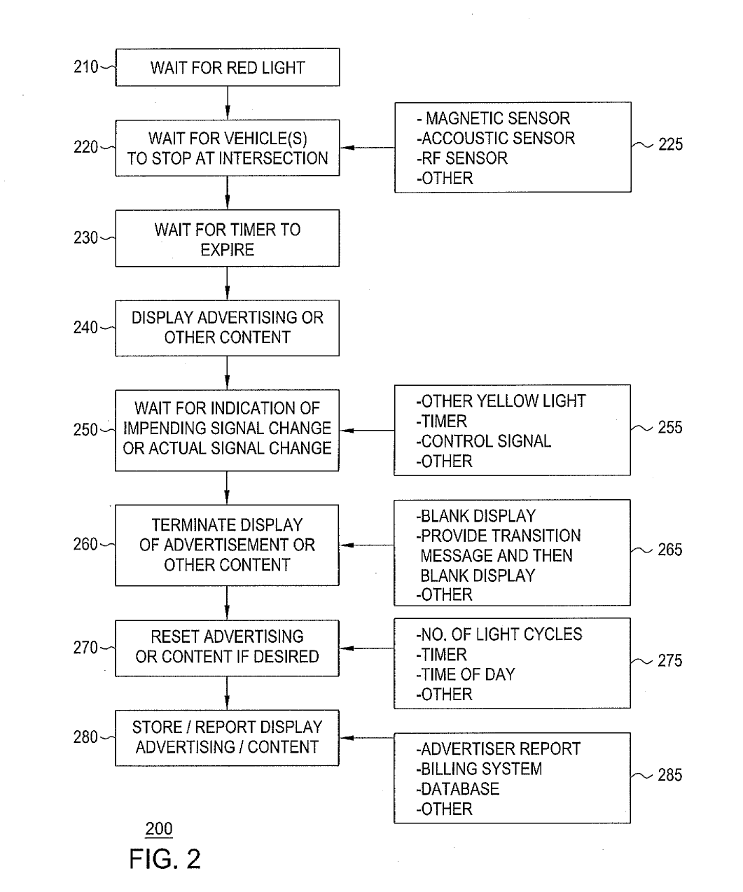

The display controller 140 communicates imagery representative video and/or data signals to the displays 150 via a control signal DC. Advertising or other content associated with the imagery is stored, in one embodiment, a content storage portion 146-CO of the memory 146 of display controller 140. The memory 146 stores software instructions which, when executed, perform various method according to the embodiments such as a synchronization program 146-SP which will be described more detail below with respect to FIG. 2, as well as other programs 146-OT.

The plurality of displays 150 comprise, illustratively, four displays denoted as 150N, 150S, 150E and 150W which are physically mounted proximate to corresponding traffic lights 130N, 130S, 130E and 130W. Each of the displays 150 is aligned with its corresponding traffic light 130 such that a vehicle in intersections viewing a particular traffic light 130 may also readily view the corresponding display 150.

While not shown, it will be appreciated that each of the displays 150 is capable of presenting or generating visual imagery in response to a video or data signal representing such imagery. Moreover, each of the displays 150 includes the appropriate hardware/software/circuitry necessary to power the display and render the visual imagery in response to the video or data signals presented thereto.

As previously noted, and as described in more detail below with respect to FIG. 2, the display controller 140 causes the displays 150 to present advertising or other content to vehicles at a controlled intersection. The presentation of this imagery and optional audio information occurs only during the time period within which the vehicle is stopped at the traffic light. To determine when the traffic lights are red, yellow or green states it is necessary to provide this information to the display controller 140. Various embodiments utilize different techniques to provide this information to the display controller 140.

In one embodiment, traffic light state information is provided to the display controller 140 directly from the traffic signal controller 110.

In another embodiment, a control signal sensor 160C senses the control signal SC provided to the power switch 120 by the traffic signal controller 110 and responsively provides a corresponding signal C-SENSE to the display controller 140.

In another embodiment, one or more power signal sensors 160xP sense the driver signals provided by the power switch 120 to the various traffic lights 130 and responsively provide a corresponding signal P-SENSE to the display controller 140. For simplicity, FIG. 1 depicts only a single power signal sensor 160EP associated with an East facing traffic light 130E. However, it will be appreciated that additional power signal sensors 160WP, 160NP and 160SP may be mounted on corresponding traffic lights 130W, 130N and 130S.

In another embodiment, one or more optical signal sensors 160xO sense the optical output or light provided by the traffic lights 130 and responsively provide a corresponding signal O-SENSE to the display controller 140. For simplicity, FIG. 1 depicts only one optical detector OD and signal sensor 160EO and associated with an East facing traffic light 130E. However, it will be appreciated that additional optical detectors OD and signal sensors 160WO, 160NO and 160SO may be mounted on corresponding traffic lights 130W, 130N and 130S. In various embodiments, one optical detector OD is associated with some or all of the lights provided by a single traffic light 130 (e.g., red, yellow, green, green arrow, red arrow and so on).

The optional power backup 170 operates to keep the displays 150 illuminated in case of a power outage. In various embodiments, the backup function may be provided by a power backup source (not shown) utilized by the power switch 120 is part of the normal power backup system associated with traffic control system 100.

The remote content source 180 comprises a server or other content repository accessed by the display controller 140 using a network connection, such as a cellular telephone network, satellite network and the like. The display controller 140 is associated with or otherwise includes circuitry and software adapted to communicate with the remote content source 180 by whichever network is appropriate. Content retrieved from the remote content source 180 is stored in the content portion 146-CO of the memory 146 of the display controller 140.

The network equipment 190 suitable for generating or communicatively supporting a wireless network or Wi-Fi hotspot such as an 802.11 or WiMAX hotspot may comprise a router or other network communications device capable of performing this function. The network equipment 190 may be integrated with the display controller 140 or may be a separate unit.

The network equipment 190 provides network accessibility to vehicles within a predefined range depending upon the network technology used. In various embodiments, the network equipment 190 is connected to a cellular telephone network or other access network to provide Internet access to vehicles, the communications or network link between the display controller 140 and the remote content source 180, a communications are network link between a traffic signal controller 110 and corresponding remote programming source 115 and so on. Generally speaking, the network equipment 190 may be used for many purposes.

In one embodiment, network equipment 190 at each of a sequence of controlled traffic intersections is used to communicate messages between display controllers 140 at the various control traffic intersections such that a coherent sequence of advertising or other content may be provided to vehicles traversing the multiple traffic intersections. The coherent sequence of advertising or other content may comprise, illustratively, portions of a relatively long advertisement, different advertisements (i.e., ensure that the same advertisement is not repetitively seen by the vehicle occupant), different content and so on. Additionally, public service messages may change based upon where the vehicles located such as in the case of traffic jams near particular control traffic intersections.

In one embodiment, an emergency override is provided wherein government entities may cause specific content to be displayed on any display device and at any time, irrespective of the state of the traffic signals.

The content used for advertising presentation and the like is periodically changed based upon agreements with advertisers, local government entities and the like. The content may comprise advertising, public service messages, traffic information and the like.

In one embodiment, an advertiser contracts with the EDI owner to present specific advertising or other content for a predetermined number of traffic light cycles, predetermined number of stopped vehicles, predetermined amount of time, during a predetermined time of day and/or any combination thereof. The EDI owner tracks the presentation of this advertising or other content and stores the tracking data in memory. The tracking data is then provided to the advertiser as part of a tracking report for billing report. The advertiser pays the EDI owner based upon the agreed-upon terms of the contract.

In one embodiment, advertisers may change at any time the specific advertisements presented at intersections on their behalf. In this embodiment, new advertisements or other content are pushed to the EDI owner for subsequent updating of the display controller 140 associate with the one or more contracted controlled traffic intersections. In other embodiments, the EDI owner pulls updated advertisements or other content from the advertiser or other content provider periodically, after predefined number of presentations, in response to changes in the time of day and so on.

In one embodiment, the various technologies are used to count the number of cars stopped at an intersection. In this manner, the number of vehicles having occupants able to is viewed a particular advertisement may be tracked and provided to advertisers or other content providers.

Revenues generated by the EDI owner due to contractual arrangements with advertisers or other content providers may be shared with local municipalities or other government entities to help fund their operations, defray the cost of road maintenance and so on. Generally speaking, various embodiments of the invention provide a mechanism wherein advertising revenue may be generated based upon the safe use of public transportation signaling infrastructure.

FIG. 2 depicts a flow diagram of an advertising synchronization method according to one embodiment. Specifically, the method 200 of FIG. 2 is suitable for execution by the display controller 140, such as via software instructions stored within the memory 146 which are executed by the processor 144 to perform the various steps discussed herein. It is noted that the method 200 described herein with respect to FIG. 2 is related to the operation of a single display 150. For intersection with four displays associated with four corresponding traffic lights, the method 200 of FIG. 2 is modified to perform the same basic functions for each of the four displays to synchronize display operation to respective traffic light operations.

At step 210, the method waits for the traffic light to achieve a red light state or condition. As previously noted, this condition may be sensed via various means 160, which means convey the information to the display controller 140.

At optional step 220, the method waits for one or more vehicles at the intersection portion facing the display to stop. As noted in box 225, this determination may be made with respect to magnetic sensors embedded in the road that detect vehicles, acoustic sensors and/or RF sensors that detect vehicles and other techniques. While not shown in the various drawings, such sensors are known to those skilled in the art and currently used in controlled intersections.

At optional step 230, the method waits for a timer to expire. The expiration of the timer may allow time for cars approaching the intersection to come to a complete stop.

Steps 220 and 230 are designed to provide time in which a moving vehicle may come to a stop such that the initiation of advertising or other content display on the display device, to strike the driver of a moving vehicle. The steps are used in various embodiments, but not all embodiments.

At step 240, the method begins displaying advertising or other content on the display device.

At step 250, the method waits for an indication of an impending signal change or actual signal change. In one embodiment, the advertising or other content display initiated at step 240 terminates when the traffic light of interest changes from red to green (i.e., an actual signal change). In another embodiment, the advertising or other content display initiated at step 240 terminates prior to the traffic light of interest changing from red to green. For example, referring to box 255, the method waits for an indication of a yellow light at another traffic light (i.e., without yellow light will be followed by a red light at the traffic light of immediate interest), the expiration of a timer, the change in a control signal such as provided by the traffic signal controller 110 or some other indication of impending signal change.

At step 260, the method terminates the display of the advertisement or other content. Referring to box 265, the termination of the displayed imagery may be accomplished by blanking or turning off the display device, providing a transition message to the vehicle occupant and then blanking the display or some other means.

At optional step 280, data associated with the display of advertising or other content is stored in memory or otherwise reported to an entity tracking the display of such advertising or other content. For example, in various embodiments in particular advertiser may pay each time their advertisement is displayed. In addition, the payment of the advertiser may depend upon the number of vehicles that view the display (i.e., the number of vehicles stopped in front of the traffic light of interest). The number of vehicles stopped in front of the traffic light of interest may be determined by various means, such as the mechanisms discussed above with respect to box 225.

It should be noted that functions depicted and described herein may be implemented in software and/or in a combination of software and hardware, e.g., using a general purpose computer, one or more application specific integrated circuits (ASIC), and/or any other hardware equivalents. In one embodiment, software implementing methodology or mechanisms supporting the various embodiments is loaded into memory 146 and executed by processor(s) 144 to implement the functions as discussed herein. Thus, various methodologies and functions (including associated data structures) can be stored on a computer readable storage medium, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in tangible fixed or removable media, transmitted via a data stream in a tangible or intangible broadcast or other signal bearing medium, and/or stored within a memory within a computing device operating according to the instructions.

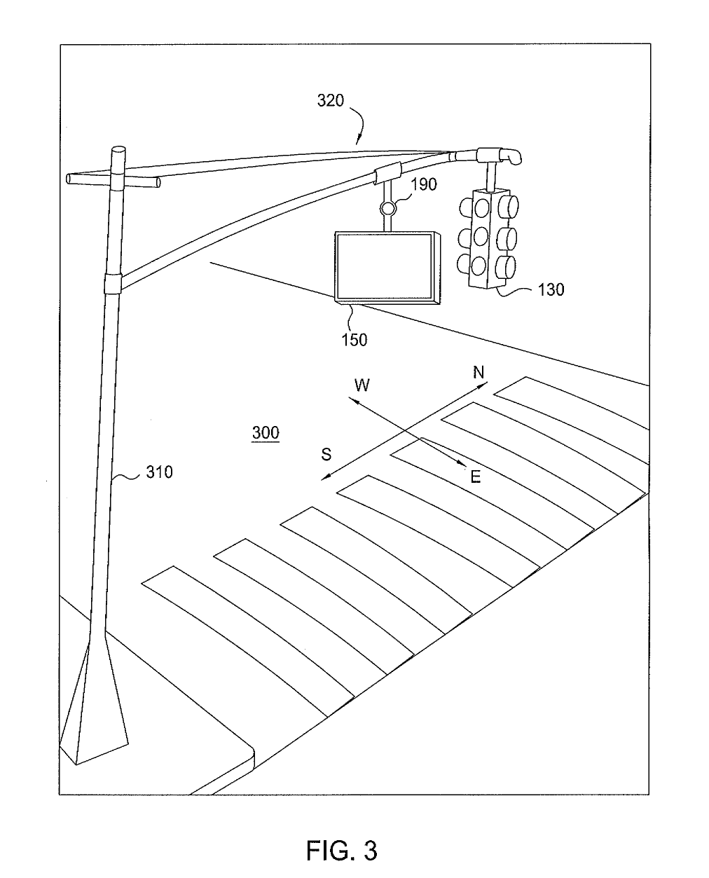

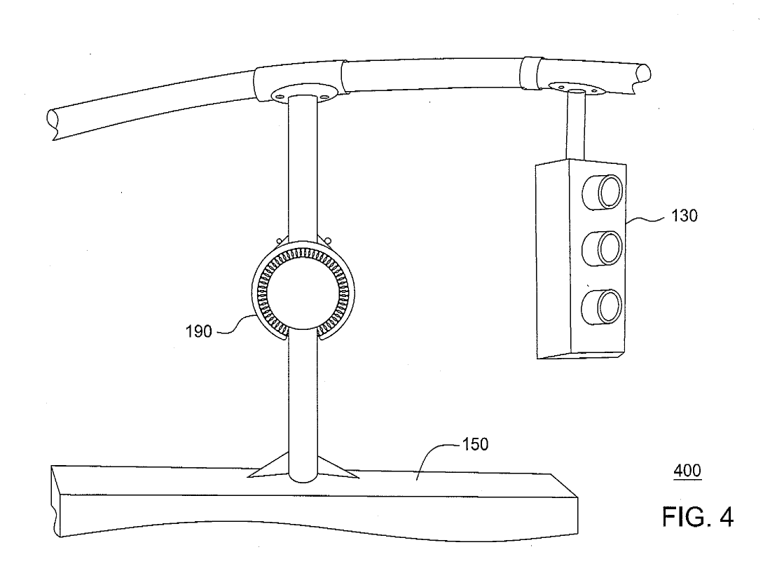

FIGS. 3-4 depict display system installations proximate traffic lights according to several embodiments. Specifically, FIGS. 3-4 depict an intersection 300 in which a poll 310 supports a cross-member 320 from which a traffic light 130, display 150 and network equipment 190 are secured. It is noted that a single traffic light 130 and single display 150 are shown; however, as will be appreciated there may be multiple traffic lights and multiple displays provided in this manner.

FIG. 5 depicts a system according to one embodiment. Specifically, the system 500 of FIG. 5 comprises a central control system 116 in communication via a primary communication channel 105P with a remote content source 118, a remote program source 115, an emergency content source 117, a backup communication system 118 and a backup power source 510.

The central control system 116 communicates with a plurality of local traffic control systems (depicted as the EDI portion 102 of a traffic control system 100) via a primary network 104P to provide thereby the various control functions previously described with respect to FIG. 1. It is noted that the EDI portions 102 of local traffic control systems 100 are depicted as forming respective nodes or network elements within a traffic control and display system network 104. While these nodes or network elements are depicted in FIG. 5 as forming a mesh network, it will be appreciated by those skilled in the art that other network topologies may be employed within the teachings of the invention.

The central control system 116 communicates advertising content, traffic light sequencing information, emergency service content, Amber alert messages, service/status information and the like to the local traffic control systems 100 via the primary network 104P. The central control system 116 may also receive status messages from the local traffic control system 100 via the primary network 104P.

The backup communication system 118 is adapted to communicate necessary information to the local traffic control systems 100 via a backup network 104B. The backup communication system 118 communicates via a backup communication channel 105B with the remote content source 118, the remote program source 115, the emergency content source 117, the central control system 116 and the backup power source 510.

The backup communication system 118, backup communication channel 105B and backup network 104B may be implemented using a redundant technology similar to the corresponding primary functions or using an entirely different technology. In one embodiment, the backup communication system 118 utilizes a satellite-based communication system to communicate with the remote content source 118, the program source 115 and/or emergency content source 117. In one embodiment, the backup communication system 118 interacts with the emergency content source 117 and not the remote content 118 and program 115 sources. In one embodiment, the backup network 104B comprises a cellular telephone network while the primary network 104P comprises a hardwired optical or electrical network.

While the foregoing is directed to various embodiments of the present invention, other and further embodiments of the invention may be devised without departing from the basic scope thereof. As such, the appropriate scope of the invention is to be determined according to the claims, which follow.

1. A method for providing electronic messages to a vehicle occupant at a controlled intersection, comprising:
in response to a determination that a traffic light facing a vehicle is in a stop state and that said vehicle has stopped moving, presenting imagery upon a display device visually aligned with said traffic light such that occupant of said vehicle may view said imagery.

2. The method of claim 1, further comprising presenting said imagery a predetermined time period after said traffic light entered said stop state.

3. (canceled)

4. The method of claim 1, wherein the determination that said vehicle has stopped is made using data derived from any of a magnetic road sensor, an acoustic sensor and a radiofrequency (RF) sensor.

5. The method of claim 1, further comprising terminating the presentation of said imagery upon the display device in response to a determination that the traffic light facing the vehicle is not in a stop state.

6. The method of claim 1, further comprising terminating the presentation of said imagery upon the display device in response to a determination that a traffic light not facing the vehicle has entered a prepare to stop state.

7. The method of claim 5, wherein transitional imagery is presented upon the display device prior to terminating the presentation of imagery upon the display device.

8. The method of claim 1, wherein the imagery presented upon the display device is periodically changed.

9. The method of claim 8, further comprising storing data indicative of the number of times specific imagery has been presented upon the display device.

10. The method of claim 9, further comprising providing said stored data as part of a report to an advertiser or a report to a billing system.

11. The method of claim 1, further comprising contemporaneously presenting audio information with said presented imagery.

12. The method of claim 1, further comprising generating a network hotspot having a footprint overlapping a network hotspot generated at a neighboring traffic light.

13. The method of claim 12, further comprising coordinating a sequence of image presentations at neighboring traffic lights.

14. The method of claim 1, further comprising:
retrieving content to be presented from a remote content source;
displaying retrieved content according to an advertising contract; and
reporting content presentation data to an advertiser.

15. An Electronic Display Interface (EDI) for use at a controlled intersection, the EDI comprising:
a display visually aligned with a corresponding traffic light; and
the controller, operative to cause the presentation of imagery upon the display when the corresponding traffic light is in a stop state of operation and one or more vehicles facing said traffic light have stopped moving.

16. The EDI of claim 15, further comprising network equipment for generating a network hotspot.

17. The EDI of claim 15, further comprising:
one or more additional displays, each of said additional displays being aligned with a corresponding traffic light; wherein
the controller is operative to cause the presentation of imagery upon each display having a corresponding traffic light in a stop state.

18. The EDI of claim 15, further comprising a memory for storing content for subsequent presentation, said content being periodically refreshed using a remote content source.

19. The EDI of claim 15, wherein said controller receives at least one signal indicative of said state of said traffic light, said provided by any of a control signal sensor, a power signal sensor and an optical signal sensor.

20. The EDI of claim 19, wherein said power signal sensor is operative to detect changes in drive signals associated with said traffic light and said optical signal sensor is operative to detect changes in optical output associated with said traffic light.

21. The EDI of claim 15, further comprising a vehicle detector comprising one or more of a magnetic road sensor, an acoustic sensor and a radiofrequency (RF) sensor.
